(19) United States
(12) Patent Application Publication
(10) Pub. No.: US 2020/0019159 A1
(43) Pub. Date: Jan. 16, 2020

(54) AGRICULTURAL CONTROL AND INTERFACE SYSTEM

(71) Applicant: Raven Indudstries, Inc., Sioux Falls, SD (US)

(72) Inventors: Jared Ernest Kocer, Sioux Falls, SD (US); Dominic Walkes, Sioux Falls, SD (US); Clinton Howard Mundt, Frisco, TX (US); Bruce Thompson, Kelowna (CA); Marc Roger Tibout, L'Ile-Bizard (CA); Amy Barrows, Sioux Falls, SD (US); Joshua James Skanderup, Round Rock, TX (US); Paul Welbig, Leander, TX (US)

(21) Appl. No.: 16/509,235

(22) Filed: Jul. 11, 2019

Related U.S. Application Data
(60) Provisional application No. 62/696,747, filed on Jul. 11, 2018.

(51) Int. Cl. G05D 1/00; G05D 1/02; A01B 79/00

(52) U.S. Cl. CPC G05D 1/0044; G05D 1/0291; A01C 21/005; G05D 2201/0201; A01B 79/005

(57) ABSTRACT

A machine to perform operations in a field includes a memory including instructions and processing circuitry that is configured by the instructions to receive coverage data from a server, where the coverage data is indicative of operations executed by another machine in the field. The processing circuitry that is further configured by the instructions to determine, using the coverage data, a strategy for performing operations in the field, where the strategy reduces the likelihood of the machine from processing an area of the field that was previously processed by the other machine. The processing circuitry that is further configured by the instructions to actuate the machine according to the strategy.

### CLAIM OF PRIORITY

This application claims the benefit of priority to U.S. Provisional Patent Application Ser. No. 62/696,747, filed Jul. 11, 2018, which is incorporated herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright tights whatsoever. The following notice applies to the software and data as described below and in the drawings that form a part of this document: Copyright Raven Industries, Inc.; Sioux Falls, S.D.; All Rights Reserved.

### TECHNICAL FIELD

This document pertains generally, but not by way of limitation, to control machine control systems, more particularly to control systems for collaboratively operating agricultural machines.

### BACKGROUND

Modem agricultural operations generally include the use of agricultural machines (e.g., tractors, harvesters, sprayers, seeders, tillers, combines, etc.) to process fields, such as by planting, harvesting, or generally tending to a crop. Such agricultural machines can include control systems that automate, or assist operators in, the execution of these operations. Such control systems can provide operators with information such as direction, speed of the vehicle, agricultural implement data, agricultural product application rate, and the like. Such control systems can also help agricultural machines navigate a field along predetermined paths or trajectories.

Some agricultural operations benefit from using agricultural machines collaboratively to process fields, such as when two or more machines perform the same set of operations on a field. During the execution of such operations, it is desirable to minimize the amount of time required to perform a task, such as by avoiding situations where a machine processes, or covers, an area of a field that was previously processed by another machine.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1 illustrates an example of an environment including a system to coordinate agricultural operations in a field.

FIG. 2 illustrates an example of machine controller at is useful for controlling a machine for performing operations in a field.

FIG. 3 illustrate an example of an environment including a set of collaborative machines for processing a field.

FIG. 4 illustrates an example of a screen shot of a machine user interface showing the guidelines determined by a machine based on coverage data of another machine.

FIG. 5 illustrates an example of a screen shot of a machine user interface showing the guidelines determined by a machine based on coverage data of another machine.

FIG. 6 illustrates an example of an interface including a coverage report of a field.

FIG. 7 is a diagram of a process for coordinating collaborative machines in a field.

FIG. 8 is a diagram of a process for operating a collaborative a machine to process a field.

FIG. 9 illustrates a block diagram of an example machine 900 upon which any one or more of the techniques (e.g., methodologies) discussed herein can perform.

### OVERVIEW

The present inventors have recognized, among other things, that a problem to be solved can include preventing duplicate work during a task. For example, when more than one machine (e.g., agricultural machine) are tasked with applying an agricultural product to a field, overlapping coverage areas results in double application of the product. Such overlap is wasteful, inefficient, and in some instances can be harmful to the crop. Similarly, miscommunication between operators processing a field can cause sections of crops to be completely missed. This also is harmful to the crop because the crop does not receive the desired agricultural product.

In another example, a first machine applying that is processing a field, such as by applying an agricultural product to the field, can be later joined by a second machine. The operator of the second machine may be unaware of which areas were processed by the first machine. While the operation of the second machine can communicate with the operator of the first machine to determine processed areas, such communication can be inexact, leading to improper field processing, such as through either overlapping or missed areas.

Aspects of the present disclosure address these problems, and others, by providing techniques (e.g., systems, machines, and methods) to guide or control machines in a fleet of two or more machines based on coverage data received from other machines in the fleet. Such coverage data can include spatial positions of the other machines, implement configurations, environmental parameters (e.g., terrain and obstacle information), machine parameters, or other data generated by, or related to, the machines in the fleet and relayed by a server. More specifically, coverage data is communicated between machines through the use a common server. These techniques enable machines to make local guidance and operation (e.g., product application or implement actuation) determinations at the individual machine based on the coverage of other machines, thereby reducing or minimizing bandwidth requirements.

This overview is intended to provide an overview of subject matter of the present patent application. It is not intended to provide an exclusive or exhaustive explanation of the invention. The detailed description is included to provide further information about the present patent application.

### DETAILED DESCRIPTION

According to an aspect of the present disclosure, machines are provided to perform operations or a task in a field (hereinafter, to “process a field”). The machines can include any field processing machine, such as machines (e.g., combines, harvesters, planters, sprayers, or tractors) that traverse a field to perform a task. Processing a field can include tilling, harvesting, planting seeds, spraying crops, or applying agricultural products. Such agricultural products can include solid products, such as granular fertilizer, or liquid products, such as fertilizers, herbicides, or pesticides.

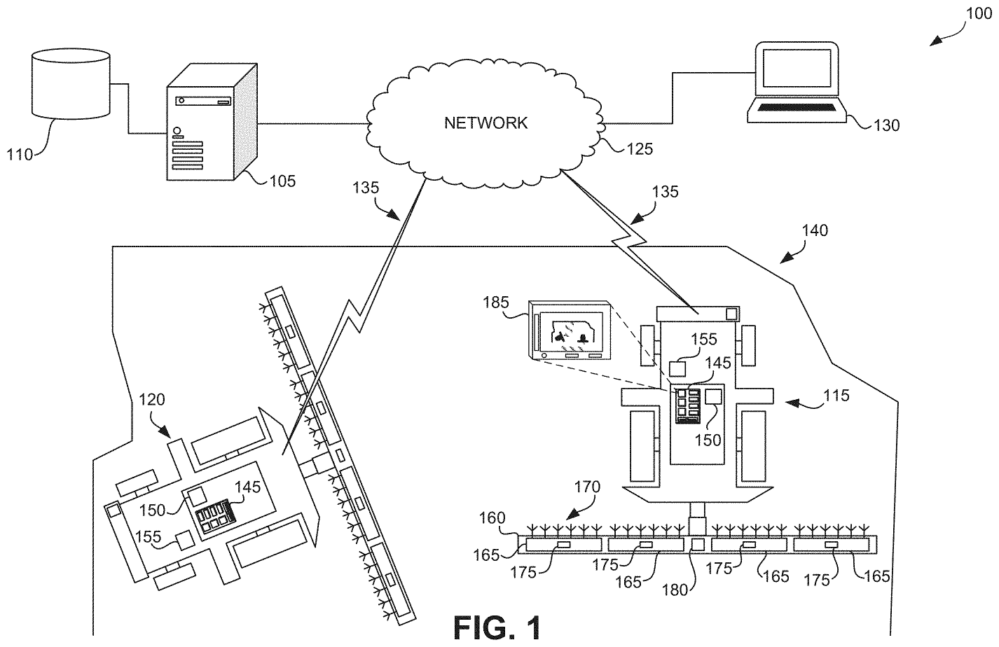

FIG. 1 illustrates an example of an environment for implementing a technique for coordinating agricultural operations in a field. The environment 100 can include the machines 105 and 110, an interface server 105, and a data communication network 125. In some examples, the environment 100 includes a database system 110 and a client computing device 130. One or more components of the environment 100 can be coupled together, such as to exchange information, by wired or wireless elements of the data communication network 125.

The interface server 105 can include any computing system or computer server that is configured, such as by one or more hardware circuits or through programing with one or more specially configured software applications, to collect field coverage information from, and distribute field coverage information to, one or more remote computing systems, such as machine controllers 145 on the machine 115 or 120 (e.g., agricultural machines). The interface server 105 can also be configured to distribute, such as through a website interface, coverage information to one or more remote computing systems, such as the computing device 130. In an example, the interface server 105 is configured to facilitate the collaborative operation of two or more machines 115 and 120 to perform a task, such as processing a bounded filed 140. The field 140 can be any field that can be processed to harvest or cultivate resources, such as agricultural field where used to cultivate a row crop. The task can include any set of one or more operations to process the field 140. In an example, the task can include collaborative deposition a pesticide over the surface of the field 140.

In an example, the interface server 105 can communicate a task to the machines 115 and 120, such as in response to a request received from a machine controller 145. Such request can be submitted by an operator through use of the machine controller 145. In another example, the interface server 105 communicates a task to machines 115 and 120 in response to a request received from the remote computing device, such as a request submitted the computing device 130 through a website interface to the interface server 105. In other examples, the task can be manually received by an operator of the machines 115 and 120.

The interface server 105 can organize one or more machines that are task with collaboratively processing the field 140 in to a job group. A job group can include as specific task and a group of machines or operators authorized to work on the task. The interface server 105 can be configured to manage one or more jobs. The interface server 105 can control access to a job group using authentication tokens, such as unique identifiers allocated to each machine in a job group. Such access control can ensure that only selected machines are able join in performing a task or access coverage data generated by machines working on the task, thereby preventing unauthorized machines from performing the task or accessing such coverage data. In an example, the interface server 105 only accepts data transmissions from a machine, such as for association with a specified job group, when such transmissions are associated with an authentication token that indicates that the transmitting machine is a member of the specified job group. In another example, the interface server 105 only transmits or broadcasts coverage data provided by a machine in a job group to other machines in the same job group. This can ensure that only data or other information related to the job or task of a machine is transmitted over a communication channel to such machine, thereby reducing bandwidth usage during field processing operations.

The machine 115 or 120 can include any machine, such as an agricultural machine, that is provided for processing a field. In an example, the machine 115 or 120 include a machine controller 145, a transceiver 150, and one or more sensors 155. In certain examples, the machine 115 or 120 can include an implement 160. The machine controller 145 can include one or more hardware circuits or software applications that are configured to control the operation of the machine 115 or 120, such as by capturing and processing sensor data generated by the sensors 155, controlling the operation implement 160, or monitoring, processing or exchanging job or task related data between the machine and the interface server 105.

The transceiver 150 can include any wireless network communication device, such a radio transceiver or an optical or line of sight communication device, that is configured to exchange digital information between the machine 115 or 120 and the interface server 105. In an example, the transceiver 150 is configured, such as by the machine controller 145, to exchange such information over one or more wireless communication channels 135, such as control and data channels, using sequenced or un-sequenced packed communication. In some examples, communication channels, or access to data exchanged over a communication channel, is restricted to members of a specified job group.

The sensors 155 can include any senor devices that are configured to capture or provide machine or job status information for the machines 115 or 120. In an example, the sensors 155 include imaging sensors, such as cameras and range finding or distance measuring devices, that can detect environment characteristics related to objects or obstructions in the field 140. Such objects or obstructions can include ponds, trees, powerlines, ditches, irrigation systems, or any other obstacle that may be encountered in the field 140. In another example, the sensors 155 include positioning device, such as global positing devices, for determining the location of the machine 115 or 120. In other examples, the sensors 155 include devices for monitoring the application of products to the field 140, such flow rate sensors, or for detecting or controlling the actuation of an implement, such as the implement 160. In an example, the sensors 155 are affixed to the machine 115 or 120. In other examples, the sensors 155 are affixed to the implement 160, such as flow rate sensors coupled to spray nozzles 170.

The implement 160 can include any machine actuatable or controllable implement for processing the field 140, such as a boom, sprayer, seeder, or tiller. In an example, the implement 160 includes one or more actuation device, sensor, or circuit 175 that is directly controllable by the machine controller 145. In other examples, the implement 160 includes a control circuit, such as an implement controller or microcontroller unit 180, that provides a control interface between the machine controller 145 and the one or more actuation device, sensor, or circuit 175. In some examples, the implement 160 include on or more sections 165 that can be actuated (e.g., turned on or off, or lifted and lowered) independently of other sections.

In operation, the interface server 105 can received data transmissions having coverage data from one or more machine performing a task in the field 140. Such coverage data can include any information that is indicative of work or operations executed by the machine to process the field 140, such as information that is captured or generated by the machine sensors 155 or the implement sensors 175. In an example, the machine 120 (e.g., the machine controller 145) can capture machine position information (e.g., GPS coordinates of the machine), implement position information (e.g., information indicating whether an implement is extended and engaging the field or retracted), machine speed, or product application rates as the machine traverses the field 140. The captured coverage data can be processed (e.g., conditioned) by the machine controller 145 and transmitted to the interface server 105, such as by using the transceiver 150. In an example, the coverage data is captured and transmitted to the interface server 105 periodically, asynchronously (e.g., in response to an event, such as a change in sensor input, a change in field condition, or an action by an operator), or continuously during the operation of the machine 120. In an example, the coverage data is stored in a log or database on the machine 120 and transmitted to the interface server 105 at a specified time, such as by manual transfer by an operator (e.g., using a portable storage device) or through interfacing with a data communication network after the machine 120 leaves the field 140. In an example, the machine coverage is transmitted in a set of one or more transmissions or using sequenced data packets. Such transmissions or data packets can include an authentication token, as described herein.

In response to receiving the data transmission having the coverage data, the interface server 105 can evaluate the authentication token associated with the transmissions to verify that the transmitting machine is a member of a specified job group. After authenticating the received transmissions, the interface server 105 can store the provided coverage data in database system, such as the database 110. The interface server 105 stores multiple coverage data transmissions that is received from the machine 120 in database repository that preserve the sequence in which the data is received, such as by utilizing sequence numbers, times stamps, or other sequencing mechanisms included with the received data. In some examples coverage data received from the machine 120 is stored in a partition of the database repository that is allocated to store data received from machines that members of job group to which the machine 120 belongs.

The interface server 105 can transmit the coverage data received from one or more machines in a job group to other machines (e.g., machine 115) in the job group, such as by broadcasting the data over the wireless communication channel 135 or by using any other multicasting or unicasting data communication technique. In an example the coverage data is transmitted or broadcasted such that only machines that are authenticated as belonging to a specified job group can receive or process the coverage data. In another example, the interface server 105 transmits or broadcasts the coverage data received from each machine to a job group using techniques (e.g., timestamps or sequence numbers) that preserves, or enables a receiving to machine to reconstruct, the sequence in which the data is received from each machine that provided the coverage data.

Members of a job group that are present on the field 140, or that are within the communication range of the network 135, can receive the broadcasted coverage data of other job group members from the interface server 105. A new machine that enters the field can authenticate itself with the interface server 105, such as by transmitting an authentication request including the appropriate authentication token, to receive coverage data stored by the interface server. In an example, the interface server 105 can receive an authentication request from a new machine, such as the machine 115, authenticate the request, and transmit or broadcast stored coverage data that was received from machine 120 to the new machine. As a result, machines that are new to a field can obtain previously provided coverage data of any machine in their job group, including machines that hare left or retired from the field.

Coverage information received at a machine, such as the machine 115, can be stored and processed, such as by the machine controller 145, such as to determine areas of a field that have been processed by other machines that are in the same job group, such as the machine 120. In an example, the machine 115 can process a sequence of spatial position coordinates received in the coverage data of the machine 120, along with provided the task, the environment, and machine or implement characteristic information, to determine the path or route (e.g., a last path or nearest path) taken by the machine 120 through the field 140. The machine 115 can also use implement sensor information (e.g., information indicating the times and locations where a boom was extended or when a product was applied to the field) received in the coverage data to determine the area (e.g., the as-applied coverage area) of the field 140 processed by the machine 120 as it processed the field along the determined path. In an example the machine 115 can use such information to locally generate a coverage map (e.g., an as-applied coverage map) of field 140, including, for example, one or more geometric shapes (e.g., colored r textured coverage polygons) that indicate areas of the field 140 that were processed by the machine 120. An operator or the machine controller 145 can use such information to guide the machine 115 through the field 140 along a route that prevents or limits the likelihood of the machine 115 duplicating the work of the machine 120.

In example, the machine controller 145 of the machine 115 can present the paths determined from the coverage data on a user interface, such as the touch screen 185. The machine controller 145 can also present a guidance path on the user interface parallel to and in proximity to the paths determined from the coverage data. In an example, an operator or the machine controller 145 can use the guidance path to guide the machine 115 through the field 140.

In an example, the machine controller 145 of the machine 115 use the information in a locally generated coverage map to automatically shut off or actuate an implement, such as a boom or spray nozzle coupled to a boom, when the machine 115 passes over an area that was already processed by the machine 120. This can prevent over application of a product or duplication of work that can be harmful to a crop or the field or be wasteful and inefficient regarding agricultural supplies. Additionally, the automatic actuation of such implements can enable synchronization of the machines 115 and 120, such as to provide accurate coverage of the field 140 even when the machines have implements of different widths or dimensions.

In an example, once a task is complete, or when the operator of the machine 115 or 120 decides to stop working on the task and leaves the field 140, the coverage data relayed to the interface server 105 is used to generate a report that is indicative to the work performed within the field. Such report can be generated automatically after the machine 115 or 120 leaves the field and can include as-applied coverage data, such as acreage covered by each machine, comprehensive coverage information, an amount of agricultural product applied to the field 140, actuation (e.g., on and off) rates of implements or of the machine, or environmental conditions of the field. Such reports can be broadcast to other machines or they can be used by managers to verify the proper completion of the task.

In an example, the interface server 105 can use coverage data received form machines 115 or 120 to generate coverage maps (e.g., as applied coverage maps), and provide such maps to one ore more remote computing device 130.

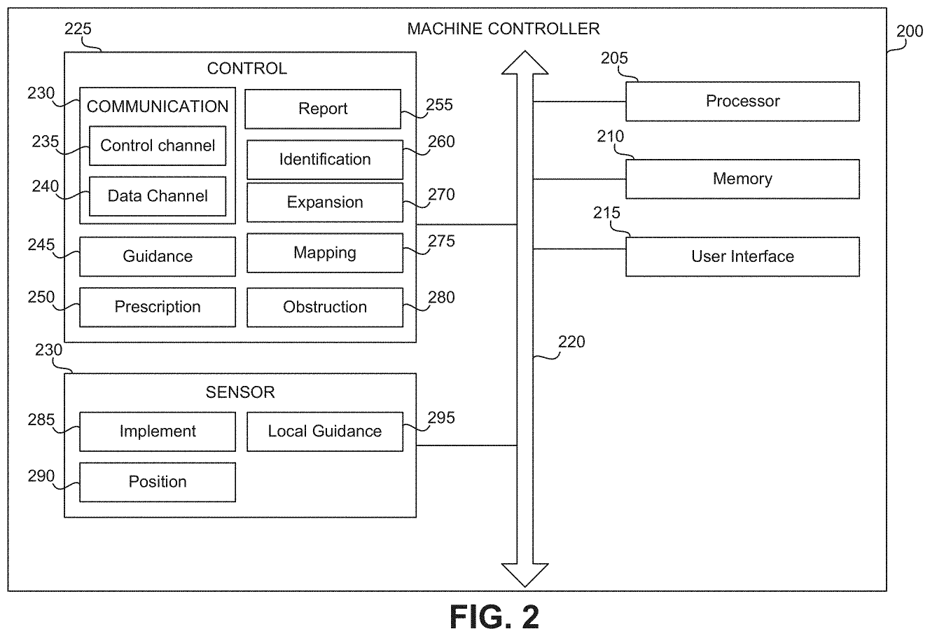

FIG. 2 illustrates an example of machine controller 200 that is useful for controlling a machine for performing operations in a field. The machine controller 200 can be an example of the machine controller 145 (FIG. 1). In an example, the machine controller 200 includes processor 205, memory 210, user interface 215, control module 225, and sensors 230. Components of the machine controller 200 are coupled together by, or can communicate through, the system bus or interconnect fabric 220. One or more components of the machine controller can be integrated into a single packaged device, while other components can be disposed in disparately packaged devices.

The processor 205 can include any processing circuit that is configured to execute instructions included in one or more software application to implement the techniques described herein.

The memory 210 can include a computer memory circuit that is configured to store instructions of a software application, such as for execution by the processor 205, and other information, such as coverage data, task data, or machine configuration information. The memory 210 can also include machine or implement profile data.

The user interface 215 can include any device for interfacing with the machine controller 200. Such devices can include a touch screen device that is configured to receive input from an operator or user. In an example, such touch screen device includes a graphic user interface (GUI), such as the GUI 185 (FIG. 1), that is configured to display coverage maps, and routing or path information.

The control component 225 includes components that include one or more circuits or software applications that are specifically configured, or that can be used to configure the processor 205, to perform or implement one or more of the operations of the techniques described herein.

The communication component 220 can include any wireless network communication device, such a transceiver 150 (FIG. 1), that is configured to exchange digital information between a machine, such as the 115 or 120 (FIG. 1), and an interface server, such as the interface server 105 (FIG. 1). In an example, a control channel 235 is provided to communicate status and configuration data information of an implement or machine, and a data channel 240 is provided to communicate location and farming operation data.

Guidance component 245 is configured to generate a guidance line for display on user interface 215 of the machine controller 200 or to control guide a machine through a field, such as according to a determined path.

The prescription component 250 operates as storage repository for task related information, such as parameters of the environment or field where the task is to be performed, parameters of the machines that will be performing the task, machine profiles, and coverage data. Such data can be received from a server, such as the interface server 105, or from one or more sensors, such as the sensors 155 or 175.

The report module 255 can be configured to generate one or more reports that is indicative of the work performed within the bounded environment, as described herein.

The identification component 260 is configured to provide, such as from the memory 210, an authentication token or unique identifier for transmitting to the server in an authentication request or any other task related communication with the server.

Expansion component 270 configured to determine machine attributes based on the received coverage data and stored characteristics of a machine or implement. Such attributes can be used by mapping component 275 to generate coverage maps, such as for a product applied to a field. Such coverage maps can include application rate maps, seed maps, or machine coverage maps. In an example, the coverage maps include polygons that are indicative of the coverage area and that are color or texture coded to show varying, or variable, rates of product application.

Obstruction log 289, can include a locally generated log of obstructions of a field, such as detected by a machine or other machines in the same job group.

Sensor component 230 can include one or more sensing device, such as implement sensors 285, spatial position sensor 290, and local guidance sensor 295. The implement sensor 285 can include one or more sensors disposed on an implement, such as to detect the configuration of the implement or measure product application rates. The position sensor 290 can include any sensor that is configured to determine the position of a machine, such as in global or spatial coordinate system. Local guidance sensor 295 can include any sensor that is configured to detect a position or orientation of a machine using local features of the environment of field. Such sensors can include cameras range finding devices or orientation detecting circuits.

Based on the task to be performed by a job group, an interface server receives information related to parameters of the environment where the task is to be performed, parameters of machines that will be performing the task, and other such task and machine related information that can be stored by the prescription component 250, the obstruction log 280, in a memory 210, or the cloud, such as to form a database of task information. In one example, a profile of each individual machine is stored at the interface server for transmission to the other machines in the fleet to be used to perform the task. This information is then transmitted through a communication component 230 from the interface server to individual machine controllers. Such transmission can be sent through a control channel 235 that provides parameters associated with status and configuration data of an implement or machine, and a data channel 240 provided for location and farming operation data exchanges.

The sensors 230 can detect performance characteristics of each machine described in relation to FIG. 1. This information is then transmitted through the communication component 230 to the interface server. Optionally, the identifier component 260 can provide a unique identifier (e.g., an authentication token) associated with the machine and sent with the detected characteristics. Based on the unique identifier, the interface server can determine if a machine is to be performing a pre-determined task. The interface server can then store the detected characteristics and send the characteristics (e.g., coverage data) to other machines performing the task, or to another machine once the new machine joins the task.

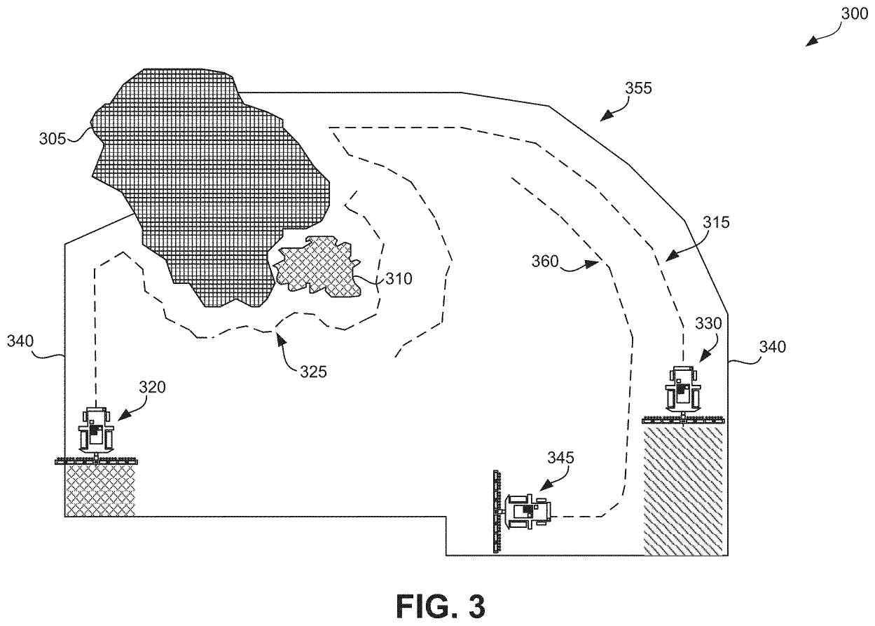

FIG. 3 illustrate an example of an environment 300 including a set of collaborative machines 320, 345, and 330 for processing a field. The machines 320, 345, and 330 can be examples of the machines 115 and 120, as shown in FIG. 1. The machines 320, 345, and 330 traverse the field 355 according requirements of a specified task. Such machines can receive environmental parameters such as the task boundary 340, location of obstacles 305 or 310, and machine characteristics of the other machines. A machine controller of each machine 320, 345, and 330 can determine a pathway for the machine to maximize coverage (e.g., application of product or processing of the field 355). In an example, a machine 330 follows a pathway 315 runs parallel to the field boundary 340, while machine 345 follows a pathway 360 that runs parallel to the pathway 315 of machine 330. Additionally, the machine 320 follows a pathway that is provided to avoid the obstacles 305 and 310. As also illustrated, the pathway 315 of machine 330 runs parallel to the pathway 325 of machine 320 once the machine 330 is in the proximity of the pathway 325.

For each machine controller, their respective pathway, position, and application rates are logged, transmitted to the interface server, then transmitted from the interface server to the other machines. Therefore, each individual machine controller receives the logged machine characteristics of the other machines and makes determinations related to the optimal pathway to efficiently maximize coverage.

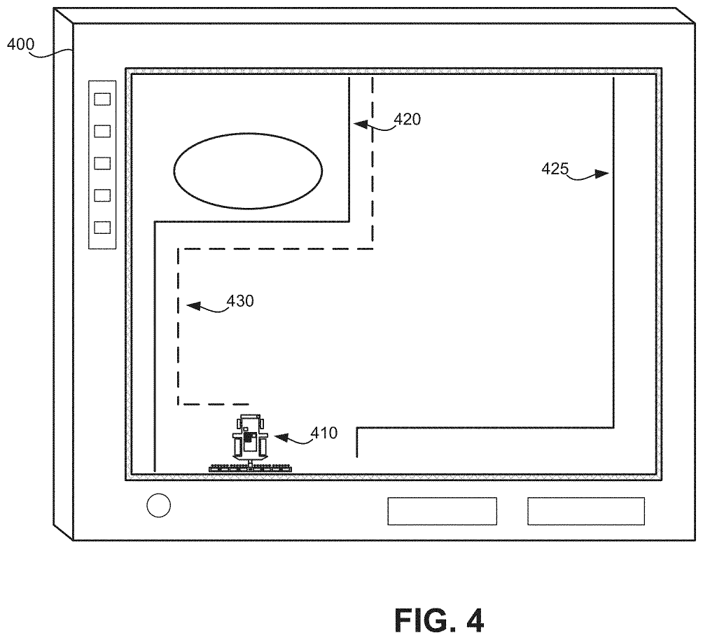

FIG. 4 illustrates an example of a screen shot of a machine user interface 400 showing the guidelines determined by a machine based on coverage data of another machine. In FIG. 4, the machine 410, such as the machine 115 or 120, is provided a guidance path 430 that is parallel to the closest path 420 that has been processed by a machine and avoids a second path 425 further away from the machine 410.

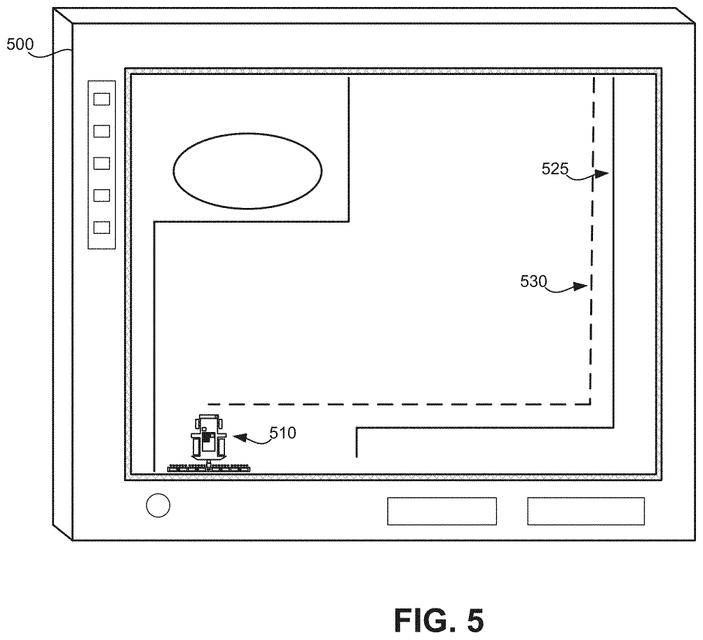

FIG. 5 illustrates an example of a screen shot of a machine user interface 500 showing the guidelines determined by a machine, such as the machine 115 or 120, based on coverage data of another machine. FIG. 5, an operator of the machine 510 can override the machine controller, such as to determine or move the path 530 of the machine by touching the machine controller interface 500 proximate to the path 525. The machine controller then alters the path 530 of the machine 510 to run parallel to the path 525, even though the path 525 is not the closest path to the machine.

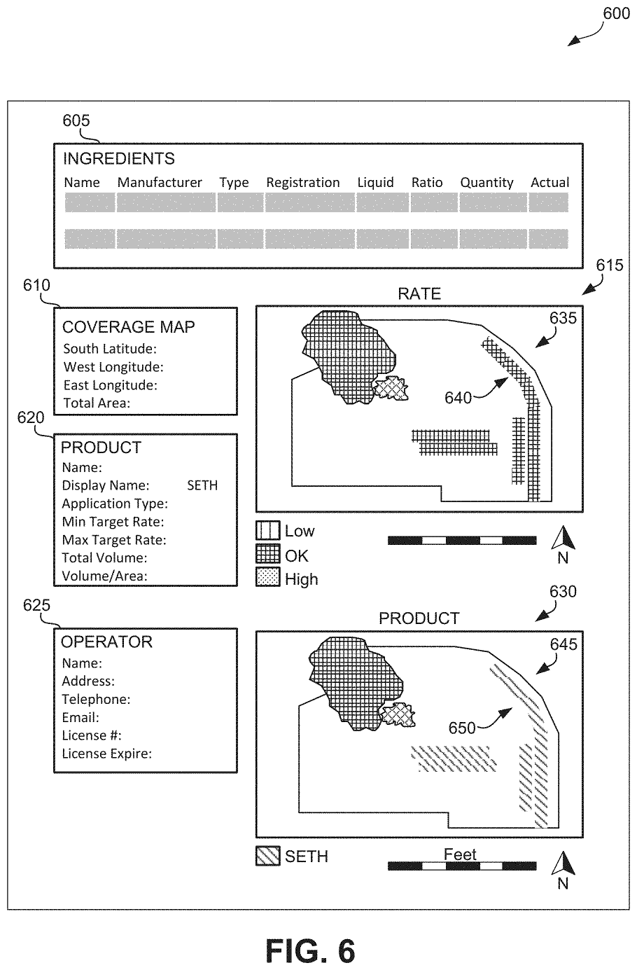

FIG. 6 illustrates an example of an interface 600 including a coverage report of a field. In an example, one or more areas of the report is provided at an interface to interface server, such as a website interface to the interface server 105 (FIG. 1). In another example, one or more areas of the report is provided in a report file or other document. The interface can include an area 605 for product information, an area 610 for coverage summary information, one or more areas 615 or 630 for a coverage map, and an area 620 for product usage or application information. The interface can also include an area 625 for machine operator information.

In an example, a report or coverage is map provided by each machine and/or at the interface server upon completion of a task, or when leaving the field 635 or 645. Specifically, a machine controller can determine when the task is complete, or when a machine leaves the field 635 or 645 and transmits information to the interface server to generate the final report 600. The final report 600 can include operator information, time of performance, application rates and areas, and the like for the individual machine. This information can be stored at the interface server, in a memory, on the cloud, or the like and printed for analysis.

Such reports can include coverage maps 635 or 645 indicating where and how much agricultural product has been applied in the field. Such maps 635 or 645 can be color coded or texture coded to identify the amount of agricultural product in a given area. Areas 640 or 650 of a field covered by an agricultural product can be depicted as individual polygons that show the application rate. Using these maps, the machine control systems can vary application rate, or even cease application of agricultural product over areas as the machine traverses through the field over areas where agricultural product has previously been applied.

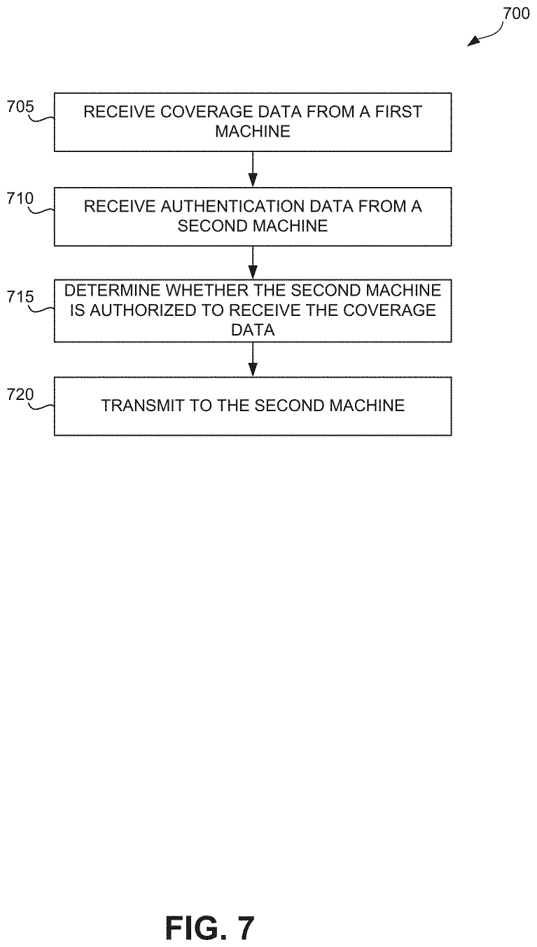

FIG. 7 is a diagram of a process 700 for coordinating collaborative machines in a field. The process 700 can be executed by a computing device, such as the interface server 105, to implement or perform the techniques of the present disclosure. At 705, coverage data can be received from a first machine, such as the machine 115 or 120 (FIG. 1). Such coverage data can include information that is indicative of operations executed by the first machine. At 710, authentication data can be received from a second machine, such as the machine 115 or 120. Such coverage data can include a unique identifier of the second machine. At 715, the server can determine whether the second machine is authorized to receive the coverage data of the first machine. Such determination can include evaluating the authentication data against stored authentication data, such as to determine whether the first machine and the second machine belong to the same job group. The coverage data can be transmitted to the second machine when the authentication data indicates that the second machine is authorized to receive the coverage data.

In an example, the process 700 further includes any other steps for implement the techniques of methodologies described herein.

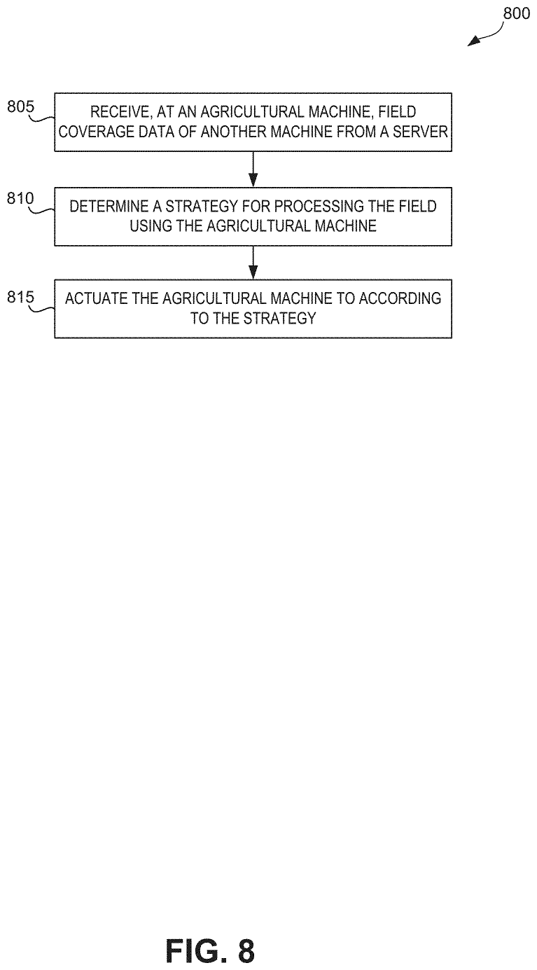

FIG. 8 is a diagram of a process 800 for operating a machine to process a field. The process 800 can be executed by a first machine, such as the machine 115 or 120 (FIG. 1), to implement or perform the techniques of the present disclosure. At 805, field coverage data (e.g., coverage data) of a second machine (e.g., an agricultural machine) is received from a server, such as the server interface 105 (FIG. 1). Such coverage data is indicative of operations executed by the second machine, such as to process field. Such coverage data can include implement configuration, implement position, section status, or product usage data. Such coverage data can also include sensor data generated by the second machine or an implement of the second machine at spatial positions indicated by the position data. Such coverage data can include spatial position data of the second machine. At 810, a strategy for processing the field using the first machine can be determined. Such strategy can include reducing or eliminating the likelihood of the first machine processing an area of the field that was previously processed by the second machine. At, 815, the first machine can be actuated according to the strategy. Such actuation includes automatically controlling the operation of an implement coupled to the first machine to prevent the first machine from processing an area of the field that was previously processed by the second machine. Such automatic control can include raising and lowing the implement, turning sections of the implement on or off, or modulating a flow rate of a nozzle used to apply a product. Such automatic control can also include guiding the first machine through the field along a route or path indicated in the strategy or selected to avoid overlapping a path processed by the second machine.

In an example the process 800 further includes any other steps for implementing the techniques of methodologies described herein.

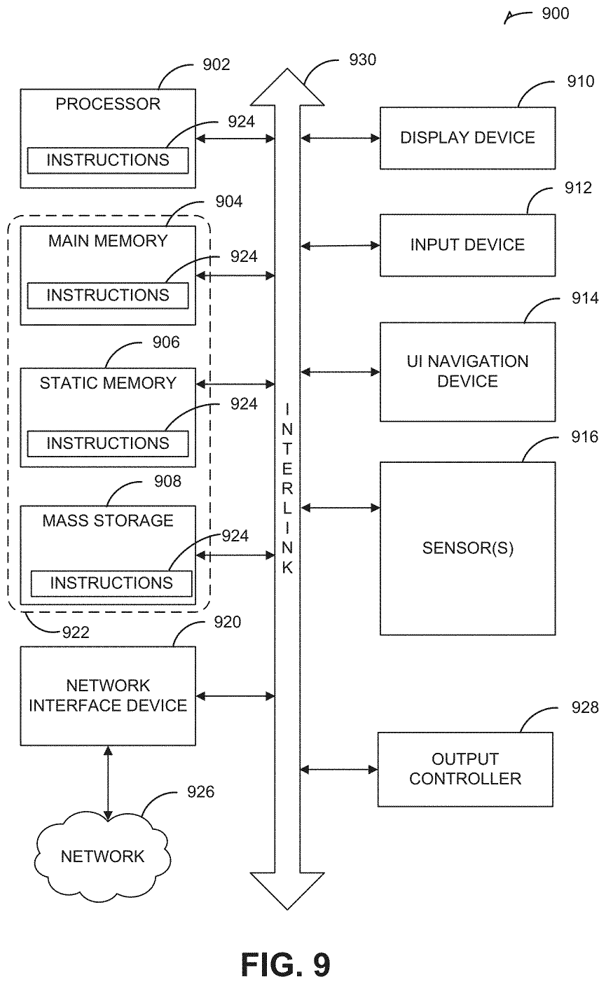

FIG. 9 illustrates a block diagram of an example machine 900 upon which any one or more of the techniques (e.g., methodologies) discussed herein can perform. Examples, as described herein, can include, or can operate by, logic or a number of components, or mechanisms in the machine 900. Circuitry (e.g., processing circuitry) is a collection of circuits implemented in tangible entities of the machine 900 that include hardware (e.g., simple circuits, gates, logic, etc.). Circuitry membership can be flexible over time. Circuitries include members that can, alone or in combination, perform specified operations when operating. In an example, hardware of the circuitry can be immutably designed to carry out a specific operation (e.g., hardwired). In an example, the hardware of the circuitry can include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time. Additional examples of these components with respect to the machine 900 follow.

In alternative embodiments, the machine 900 can operate as a standalone device or can be connected (e.g., networked) to other machines. In a networked deployment, the machine 900 can operate in the capacity of a server machine, a client machine, or both in server-client network environments. In an example, the machine 900 can act as a peer machine in peer-to-peer (P2P) (or other distributed) network environment. The machine 900 can be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein (e.g., authenticating transmissions from machines in a job group, generating coverage maps and reports, relaying coverage data, capturing and conditioning sensor information, such as generated by the sensors 155 or 175, and generating guidance information to avoid double coverage of field being processed), such as cloud computing, software as a service (SaaS), other computer cluster configurations.

The machine (e.g., computer system) 900 can include a hardware processor 902 (e.g., a central processing unit (CPU), a graphics processing unit (GPU), a hardware processor core, or any combination thereof), a main memory 904, a static memory (e.g., memory or storage for firmware, microcode, a basic-input-output (BIOS), unified extensible firmware interface (UM), etc.) 906, and mass storage 908 (e.g., hard drive, tape drive, flash storage, or other block devices) some or all of which can communicate with each other via an interlink (e.g., bus) 930. The machine 900 can further include a display unit 910, an alphanumeric input device 912 (e.g., a keyboard), and a user interface (UI) navigation device 914 (e.g., a mouse). In an example, the display unit 910, input device 912 and UI navigation device 914 can be a touch screen display. The machine 900 can additionally include a storage device (e.g., drive unit) 908, a network interface device 920, and one or more sensors 916, such as a global positioning system (GPS) sensor, compass, accelerometer, or other sensor. The machine 900 can include an output controller 928, such as a serial (e.g., universal serial bus (USB), parallel, or other wired or wireless (e.g., infrared (IR), near field communication (NFC), etc. connection to communicate or control one or more peripheral devices (e.g., a printer, card reader, etc.).

Registers of the processor 902, the main memory 904, the static memory 906, or the mass storage 908 can be, or include, a machine readable medium 922 on which is stored one or more sets of data structures or instructions 924 (e.g., software) embodying or utilized by any one or more of the techniques or functions described herein. The instructions 924 can also reside, completely or at least partially, within any of registers of the processor 902, the main memory 904, the static memory 906, or the mass storage 908 during execution thereof by the machine 900. In an example, one or any combination of the hardware processor 902, the main memory 904, the static memory 906, or the mass storage 908 can constitute the machine readable media 922. While the machine readable medium 922 is illustrated as a single medium, the term “machine readable medium” can include a single medium or multiple media a centralized or distributed database, and/or associated caches and servers) configured to store the one or more instructions 924.

The term “machine readable medium” can include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine readable medium examples can include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media can include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 924 can be further transmitted or received over a communications network 926 using a transmission medium via the network interface device 920 utilizing any one of a number of transfer protocols (e.g., frame relay, internee protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 920 can include one or more physical jacks (e.g., Ethernet, coaxial, or phone jacks) or one or more antennas to connect to the communications network 926. In an example, the network interface device 920 can include a plurality of antennas to wirelessly communicate using at least one of single-input multiple-output (SIMO), multiple-input multiple-output (WM), or multiple-input single-output (MISO) techniques. The term “transmission medium” shall be taken to include any intangible medium that is capable of storing, encoding or carrying instructions for execution by the machine 900, and includes digital or analog communications signals or other intangible medium to facilitate communication of such software. A transmission medium is a machine readable medium.

### VARIOUS NOTES & EXAMPLES

Example 1 is a machine to perform operations in a field, the machine comprising: a memory including instructions; and processing circuitry that is configured by the instructions to: receive coverage data from a server, the coverage data being indicative of operations executed by another machine in the field; determine, using the coverage data, a strategy for performing operations in the field, the strategy reducing the likelihood of the machine from processing an area of the field that was previously processed by the other machine; and actuate the machine according to the strategy.

In Example 2, the subject matter of Example 1 includes, wherein to actuate the machine according to the strategy, processing circuitry is further configured by the instructions to: automatically control the operation of an implement coupled to the machine to prevent the machine from processing an area of the field that was previously processed by the other machine.

In Example 3, the subject matter of Examples 1-2 includes, coverage data comprises spatial position data of the other machine.

In Example 4, the subject matter of Example 3 includes, wherein the coverage data further comprises: sensor data generated by the other machine or an implement of the other machine at spatial positions indicated by the position data.

In Example 5, the subject matter of Example 4 includes, wherein the sensor data comprises implement configuration, implement position, section status, or product usage data.

In Example 6, the subject matter of Examples 1-5 includes, wherein to the strategy comprises a guidance line to navigate the machine through the field, and to determine the strategy, processing circuitry is further configured by the instructions to: identify, based on the coverage data, an area of the field that was processed by the other machine; and generate the guidance line that extends adjacent to the identified area.

In Example 7, the subject matter of Examples 1-6 includes, wherein to determine the strategy, processing circuitry is further configured by the instructions to: generate, using the coverage data, a display of the as-applied coverage of the other machine.

In Example 8, the subject matter of Example 7 includes, wherein the coverage data comprises spatial position data and sensor data of the other machine, and processing circuitry is further configured by the instructions to: determine coverage geometry of the other machine using the spatial position data and the sensor data.

In Example 9, the subject matter of Examples 1-8 includes, wherein the machine or the other machine are one of a sprayer, tiller, plater, seeder, baler, swather, harvester, combine, tractor, or spreader.

Example 10 is a system to coordinate agricultural operations in a field, the system comprising: a memory including instructions; and processing circuity that is configured by the instructions to: receive coverage data from a first machine in a sequence of one or more data objects, the coverage data being indicative of agricultural operations executed by the first machine, receive authentication data from a second machine, determine, based on the authentication data, whether the second machine is authorized to receive the coverage data, and transmit, in response to determining that the second machine is authorized to receive the coverage data, the coverage data to the second machine according to the received sequence.

In Example 11, the subject matter of Example 10 includes, wherein the coverage data comprises spatial position data of the first machine.

In Example 12, the subject matter of Examples 10-11 includes, wherein the coverage data comprises machine or implement sensor information generated by the agricultural operations of the first machine.

In Example 13, the subject matter of Examples 10-12 includes, wherein the sensor information comprises: implement configuration, implement position, section status, or product usage data.

In Example 14, the subject matter of Examples 10-13 includes, wherein processing circuitry is further configured by the instructions to: generate, a coverage map of the field using the coverage information; and provide the coverage map to a client computing device through a data communication network.

In Example 15, the subject matter of Examples 10-14 includes, wherein the first machine is in a job group in a job group comprising one or more machines that collaboratively perform agricultural operations in the field, and to determine, based on the authentication data, whether the second machine is authorized to receive the coverage data is to: determine that the second machine is authorized to receive the coverage data in response to determining that the second machine is in the job group.

In Example 16, the subject matter of Examples 10-15 includes, wherein the first machine is in a job group comprising one or more machines that collaboratively perform agricultural operations in the field, and to transmit the coverage data to the second machine according to the received sequence is to: transmit the coverage data to all machines in the job group.

In Example 17, the subject matter of Examples 10-16 includes, wherein the processing circuitry is further configured by the instructions to communicate with the first machine and the second machine using a wireless communication channel.

Example 18 is a method for operating a machine to process a field, the method comprising: receiving, at a first machine, coverage data from a server, the coverage data being indicative of operations executed by a second machine in the field; determining, using the coverage data, a strategy for processing the field using the first machine, the strategy reducing the likelihood of the first machine processing an area of the field that was previously processed by the second machine; and actuating the first machine according to the strategy.

In Example 19, the subject matter of Example 18 includes, wherein to actuating the first machine according to the strategy comprises: automatically controlling the operation of an implement coupled to the first machine to prevent the first machine from processing an area of the field that was previously processed by the second machine.

In Example 20, the subject matter of Examples 18-19 includes, wherein the coverage data comprises spatial position data of the second machine.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. hi an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times, Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

As used in any example herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

“Circuitry,” as used in any example herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some examples, the circuitry may be formed, at least in part, by the processor circuitry executing code and/or instructions sets (e.g., software, firmware, etc.) corresponding to the functionality described herein, thus transforming a general-purpose processor into a specific-purpose processing environment to perform one or more of the operations described herein. In some examples, the processor circuitry may be embodied as a stand-alone integrated circuit or may be incorporated as one of several components on an integrated circuit. In some examples, the various components and circuitry of the node or other systems may be combined in a SoC architecture.

The above detailed description includes references to the accompanying drawings, which form a part of the detailed description. The drawings show, by way of illustration, specific examples that may be practiced. These examples are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other examples may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as examples may feature a subset of said features. Further, examples may include fewer features than those disclosed in a particular example. Thus, the following claims are hereby incorporated into the Detailed Description, with a claim standing on its own as a separate example. The scope of the examples disclosed herein is to be determined with reference to the appended claims, along with the full scope of equivalents to which such claims are entitled.

What is claimed is:

1. A machine to perform operations in a field, the machine comprising:
a memory including instructions; and
processing circuitry that is configured by the instructions to:
receive coverage data from a server, the coverage data being indicative of operations executed by another machine in the field;
determine, using the coverage data, a strategy for performing operations in the field, the strategy reducing the likelihood of the machine from processing an area of the field that was previously processed by the other machine; and
actuate the machine according to the strategy.

2. The machine of claim 1, wherein to actuate the machine according to the strategy, processing circuitry is further configured by the instructions to:
automatically control the operation of an implement coupled to the machine to prevent the machine from processing an area of the field that was previously^{,} processed by the other machine.

3. The machine of claim 1, wherein coverage data comprises spatial position data of the other machine.

4. The machine of claim 3, wherein the coverage data further comprises:
sensor data generated by the other machine or an implement of the other machine at spatial positions indicated by the position data.

5. The machine of claim 4, wherein the sensor data comprises implement configuration, implement position, section status, or product usage data.

6. The machine of claim 1, wherein to the strategy comprises a guidance line to navigate the machine through the field, and to determine the strategy, processing circuitry is further configured by the instructions to:
identify, based on the coverage data, an area of the field that was processed by the other machine; and
generate the guidance line that extends adjacent to the identified area.

7. The machine of claim 1, wherein to determine the strategy, processing circuitry is further configured by the instructions to:
generate, using the coverage data, a display of the as-applied coverage of the other machine.

8. The machine of claim 7, wherein the coverage data comprises spatial position data and sensor data of the other machine, and processing circuitry is further configured by the instructions to:
determine coverage geometry of the other machine using the spatial position data and the sensor data.

9. The machine of claim 1, wherein the machine or the other machine are one of a sprayer, tiller, plater, seeder, baler, swather, harvester, combine, tractor, or spreader.

10. A system to coordinate agricultural operations in a field, the system comprising:
a memory including instructions; and
processing circuitry that is configured by the instructions to:
receive coverage data from a first machine in a sequence of one or more data objects, the coverage data being indicative of agricultural operations executed by the first machine,
receive authentication data from a second machine,
determine, based on the authentication data, whether the second machine is authorized to receive the coverage data, and
transmit, in response to determining that the second machine is authorized to receive the coverage data, the coverage data to the second machine according to the received sequence.

11. The system of claim 10, wherein the coverage data comprises spatial position data of the first machine.

12. The system of claim 10, wherein the coverage data comprises machine or implement sensor information generated by the agricultural operations of the first machine.

13. The system of claim 10, wherein the sensor information comprises:
implement configuration, implement position, section status, or product usage data.

14. The system of claim 10, wherein processing circuitry is further configured by the instructions to:
generate, a coverage map of the field using the coverage information; and
provide the coverage map to a client computing device through a data communication network.

15. The system of claim 10, wherein the first machine is in a job group comprising one or more machines that collaboratively perform agricultural operations in the field, and to determine, based on the authentication data, whether the second machine is authorized to receive the coverage data is to:
determine that the second machine is authorized to receive the coverage data in response to determining that the second machine is in the job group.

16. The system of claim 10, wherein the first machine is in a job group comprising one or more machines that collaboratively perform agricultural operations in the field, and to transmit the coverage data to the second machine according to the received sequence is to:
transmit the coverage data to all machines in the job group.

17. The system of claim 10, wherein the processing circuitry is further configured by the instructions to communicate with the first machine and the second machine using a wireless communication channel.

18. A method for operating a machine to process a field, the method comprising:
receiving, at a first machine, coverage data from a server, the coverage data being indicative of operations executed by a second machine in the field;
determining, using the coverage data, a strategy for processing the field using the first machine, the strategy reducing the likelihood of the first machine processing an area of the field that was previously processed by the second machine; and
actuating the first machine according to the strategy.

19. The method of claim 20, wherein to actuating the first machine according to the strategy comprises:
automatically controlling the operation of an implement coupled to the first machine to prevent the first machine from processing an area of the field that was previously processed by the second machine.

20. The method of claim 18, wherein the coverage data comprises spatial position data of the second machine.
